(19) United States
(12) Patent Application Publication
(10) Pub. No.: US 2008/0159712 A1
(43) Pub. Date: Jul. 3, 2008

(54) IMAGING APPARATUS

(75) Inventors: Toshiro Hayashi, Chiba (JP); Nobuyuki Kodama, Kanagawa (JP); Yoshio Kusui, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/956,995

(22) Filed: Dec. 14, 2007

(30) Foreign Application Priority Data
Dec. 29, 2006 (JP) 2006-356913

(51) Int. Cl. H04N 5/00

(52) U.S. Cl. 386/117

(57) ABSTRACT

Disclosed is an imaging apparatus that includes a table rotating device rotationally drives a disc-shaped recording medium; a pickup device capable of recording an information signal of an image corresponding to light from a subject; and an external case having a disc enclosure portion and the pickup device. The imaging apparatus further includes a disc cover rotatably attached to the external case; and a cover opening/closing mechanism capable of locking and unlocking the disc cover. In the imaging apparatus, the cover opening/closing mechanism includes a fixed claw integrally provided with the disc cover and a locking claw rotatably supported on one of the external case and a case-side member fixed to the external case, the fixed claw protruding in a direction substantially perpendicular to a main surface of the disc cover, and a convex portion protruding toward the disc cover provided at a front end of the fixed claw.

### CROSS REFERENCES TO RELATED APPLICATIONS

The present application claims priority to Japanese Patent Application JP 2006-356913 filed in the Japanese Patent Office on Dec. 29, 2006, the entire contents of which is being incorporated herein by reference.

### BACKGROUND

The present application relates to an imaging apparatus including a cover opening/closing mechanism that locks and unlocks a disc cover that is rotatably attached to an external case, and in particular to an imaging apparatus that can easily and reliably lock and unlock the disc cover while using a simple structure with a reduced number of components in the cover opening/closing mechanism.

One example of a related-art imaging apparatus of this type is disclosed in Japanese Unexamined Patent Application Publication No. 2005-182877. The publication relates to an imaging apparatus including a cover opening/closing mechanism that locks and unlocks a disc cover attached to an external case so as to be openable, and in particular relates to an imaging apparatus where the cover opening/closing mechanism is disposed inside the external case in a void in the periphery of the disc drive apparatus, so that the apparatus can be reduced in size and thickness.

The imaging apparatus disclosed in the Publication includes a table rotating device that rotationally drives a disc-shaped recording medium that has been detachably mounted on a turntable, a pickup device that can record an information signal of an image, which corresponds to light from a subject inputted via at least a lens apparatus, onto the disc-shaped recording medium rotationally driven by the table rotating device, an external case in which the table rotating device and the pickup device are enclosed and which has a disc enclosure portion in which the turntable is disposed, a disc cover that is attached to the external case so as to be openable and capable of covering the disc enclosure portion, and a cover opening/closing mechanism that can lock and unlock the disc cover in a state where the disc enclosure portion is closed. The cover opening/closing mechanism includes a locking claw attached to the disc cover and a stopper claw that can engage and disengage the locking claw and is movably supported on the external case, where the stopper claw is disposed in a void inside the external case in the periphery of the table rotating device and the pickup device.

The imaging apparatus with the construction described above has a stated effect of making effective use of a void inside the external case that is unused by a disc drive apparatus, so that the external case can be reduced in size and the entire imaging apparatus can be reduced in size and thickness (see Paragraph [0014] of the specification).

However, in the related-art imaging apparatus described above, the cover opening/closing mechanism includes a slide member that is slidably supported on a base plate fixed to the external case, and the stopper claw (which corresponds to a “locking claw” for the application of this application) is supported on this slide member. A rotating lever that can lock and unlock the sliding member, a motor assembly that moves the slide member, and a coil spring that presses the stopper claw in a locking direction are also included. In this cover opening/closing mechanism, the slide member is provided in addition to the rotating lever, the motor assembly, and the coil spring, and by providing the slide member, so that the construction of the mechanism itself becomes complex. In addition, since the slide member slides, a gap for allowing the slide member to slide may preferably be provided, resulting in causing the cover opening/closing mechanism to rattle.

### SUMMARY

With the cover opening/closing mechanism of the related-art imaging apparatus, a slide member is provided in addition to a rotating lever, a motor assembly, and a coil spring, and the construction of the mechanism itself becomes complex due to the slide member. In addition, it is preferable to provide a gap of a suitable size for the sliding operation by the slide member, however, providing that gap may cause the cover opening/closing mechanism to rattle.

An imaging apparatus according to an embodiment includes a table rotating device that rotationally drives a disc-shaped recording medium detachably placed on a turntable; and a pickup device capable of recording an information signal of an image corresponding to light from a subject inputted via at least a lens device onto the disc-shaped recording medium rotationally driven by the table rotating device. The imaging apparatus further includes an external case that includes a disc enclosure portion that encloses the table rotating device and the pickup device and on which the turntable is disposed; a disc cover that is rotatably attached to the external case so that the disc enclosure portion can be opened and closed; and a cover opening/closing mechanism capable of locking and unlocking the disc cover in a state where the disc enclosure portion is closed. In the imaging apparatus, the cover opening/closing mechanism includes a fixed claw integrally provided with the disc cover and a locking claw that is rotatably supported on one of the external case and a case-side member fixed to the external case, the fixed claw protrudes in a direction that is substantially perpendicular to a main surface of the disc cover, and a convex portion that protrudes toward the disc cover is provided at a front end of the fixed claw.

According to an embodiment, the cover opening/closing mechanism includes a fixed claw integrally provided with the disc cover and a locking claw that is rotatably supported on the external case or the like, the fixed claw protrudes substantially perpendicularly to a main surface of the disc cover, and a convex portion is provided at a front end of the fixed claw. This allows to eliminate moving components such as the slide member of the existing cover opening/closing mechanism and to thereby simplify the mechanism itself. In addition, since the locking claw engages the fixed claw so as to pull in the fixed claw when the disc cover is locked, it may be possible to strongly lock the disc cover and to reduce rattling of the disc cover.

Additional features and advantages are described herein, and will be apparent from, the following Detailed Description and the figures.

### BRIEF DESCRIPTION OF THE FIGURES

FIG. 1 shows a first embodiment of an imaging apparatus according to an embodiment and is a perspective view of a digital camcorder when viewing from the front surface side;

FIG. 2 shows the first embodiment of an imaging apparatus according to an embodiment and is a perspective view when viewing from the rear surface side in a state where a display device of the digital camcorder has been opened;

FIG. 3 shows the first embodiment of an imaging apparatus according to an embodiment and is a perspective view when viewing from the front surface side in a state where a disc cover of the digital camcorder has been opened to open a disc enclosure portion;

FIG. 4 is a diagram useful in showing a driving device-side panel of the imaging apparatus according to an embodiment when viewing from an inside thereof;

FIG. 5 is a perspective view of a cover opening/closing mechanism of the imaging apparatus according to an embodiment;

FIG. 6 is a front view of the cover opening/closing mechanism of the imaging apparatus according to an embodiment;

FIG. 7 is a plan view of the cover opening/closing mechanism of the imaging apparatus according to an embodiment;

FIG. 8 is a bottom view of the cover opening/closing mechanism of the imaging apparatus according to an embodiment;

FIGS. 9A to 9C show a locking claw of the cover opening/closing mechanism of the imaging apparatus according to an embodiment, with FIG. 9A being a perspective view, FIG. 9B a front view, and FIG. 9C a plan view;

FIGS. 10A to 10C show the locking claw of the cover opening/closing mechanism of the imaging apparatus according to an embodiment, with FIG. 10A being a bottom view, FIG. 10B a left side view, and FIG. 10C a right side view;

FIGS. 11A to 11C show a cover opening/closing member of the cover opening/closing mechanism of the imaging apparatus according to an embodiment, with FIG. 11A being a perspective view, FIG. 11B a plan view, and FIG. 11C a front view, partially in cross section;

FIG. 12 is a diagram useful in showing engagement between the locking claw and a fixed claw of the cover opening/closing mechanism of the imaging apparatus according to an embodiment;

FIG. 13 is a diagram useful in showing an enlargement of the locking claw and the fixed claw that are the principal part in FIG. 12; and

FIG. 14A to 14C are diagrams useful in explaining on/off states of three switches when the locking claw and the fixed claw of the cover opening/closing mechanism of the imaging apparatus according to an embodiment engage one another.

Additional features and advantages are described herein, and will be apparent from, the following Detailed Description and the figures.

### DETAILED DESCRIPTION

A cover opening/closing mechanism includes a fixed claw integrally provided with the disc cover and a locking claw that is rotatably supported on an external case or a case-side member that is fixed to the external case, the fixed claw protrudes in a direction that is substantially perpendicular to a main surface of the disc cover, and a convex portion that protrudes toward the disc cover is provided at a front end of the fixed claw. Accordingly, an imaging apparatus where the cover opening/closing mechanism is simplified and the disc cover can be strongly locked with reduced rattling is realized with a simple construction.

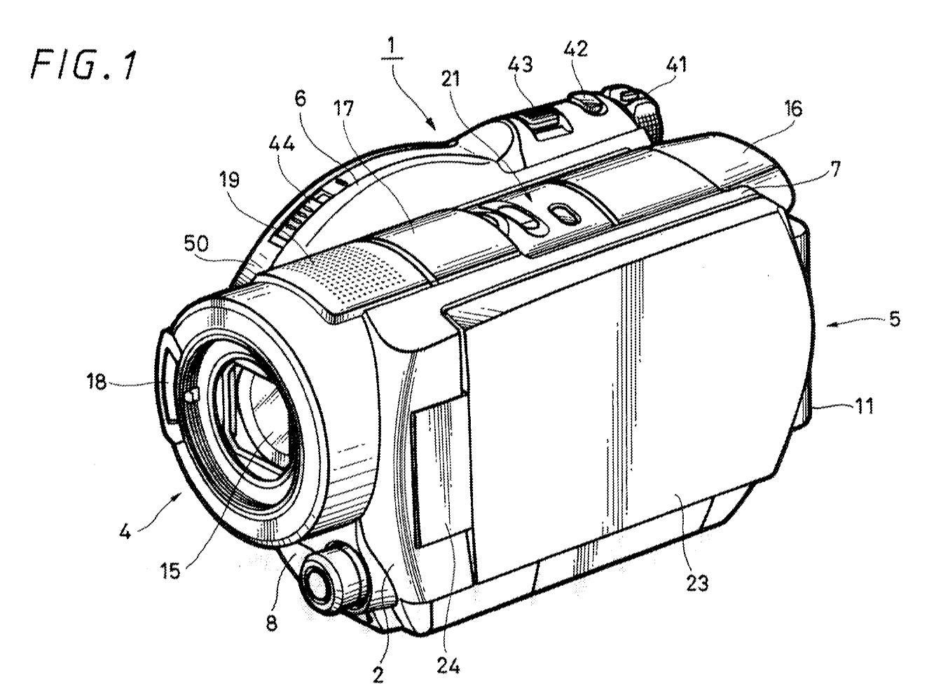

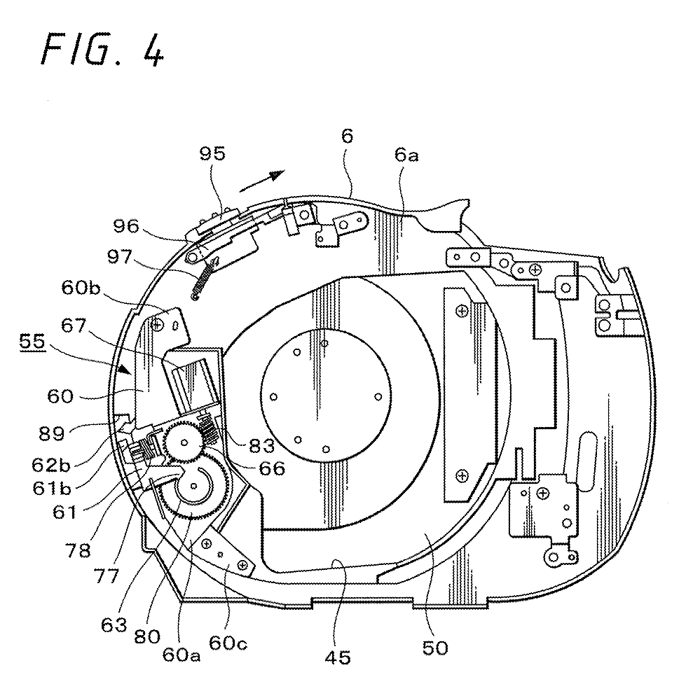

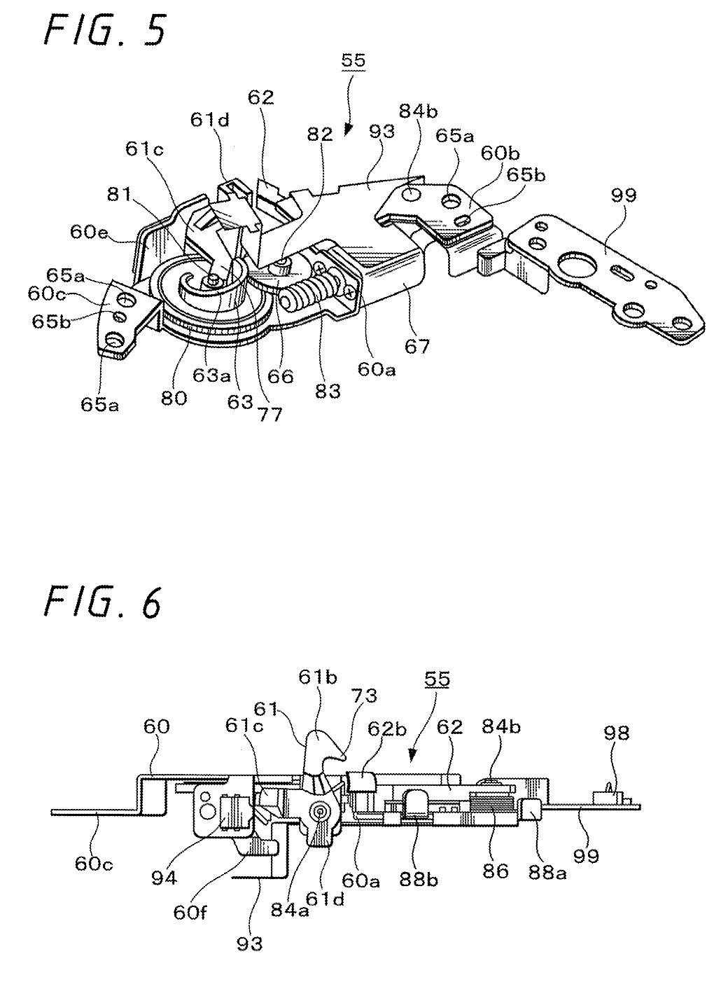

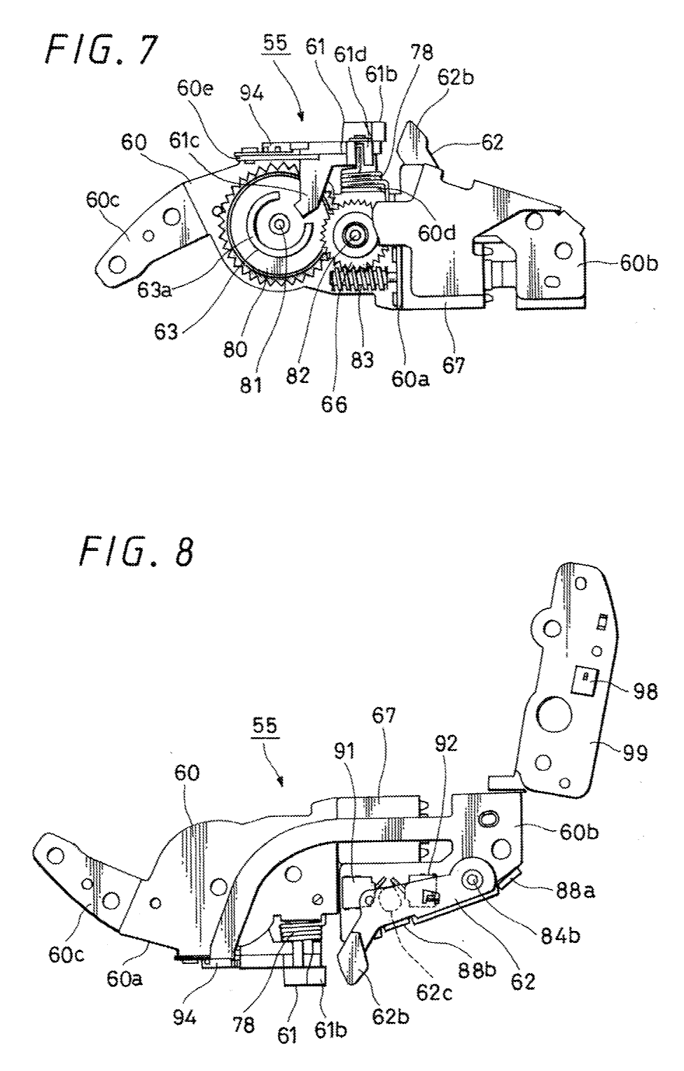

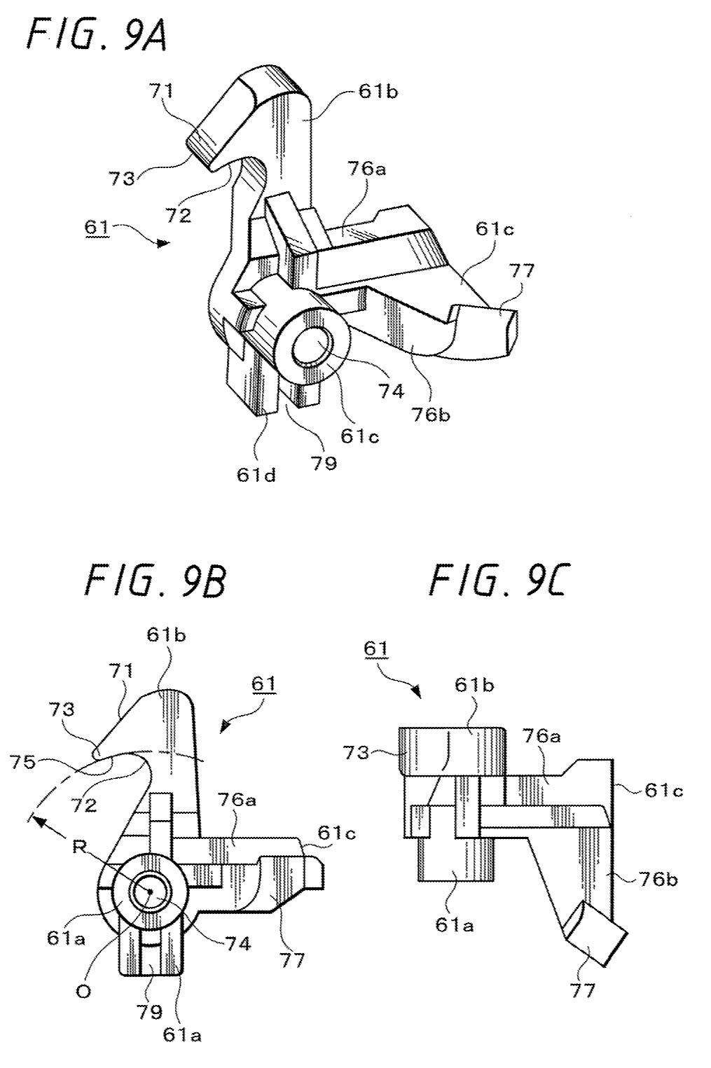

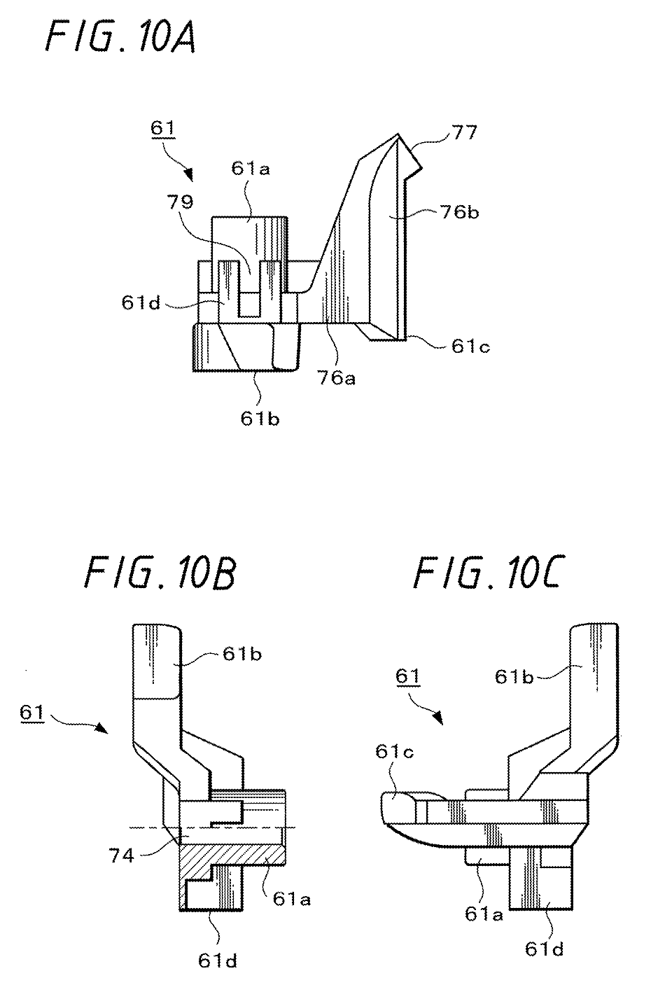

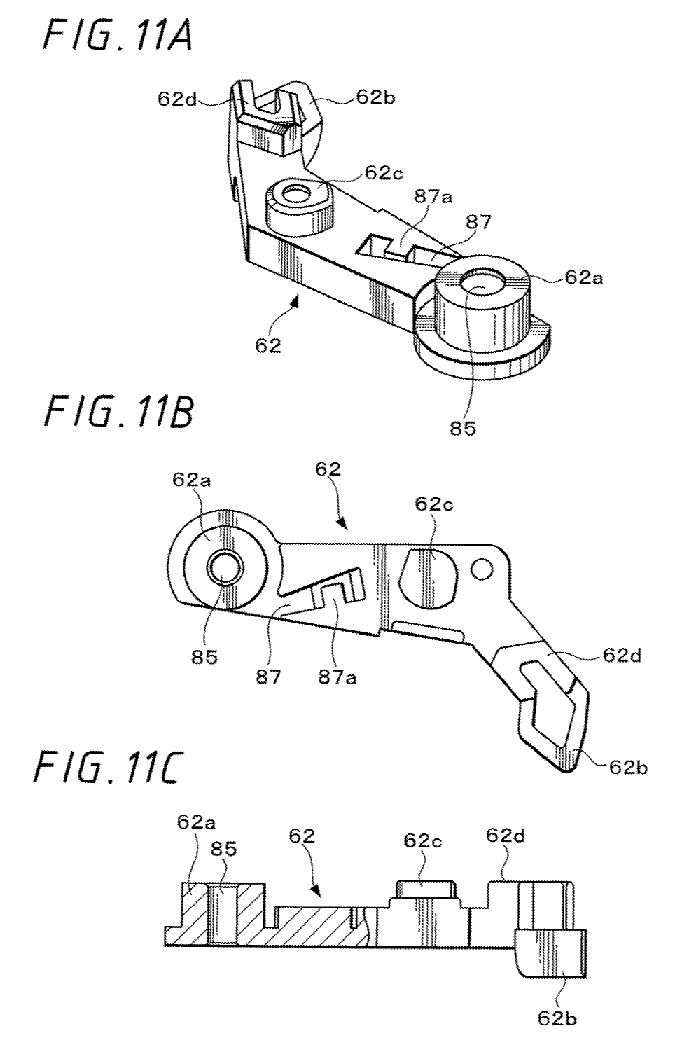

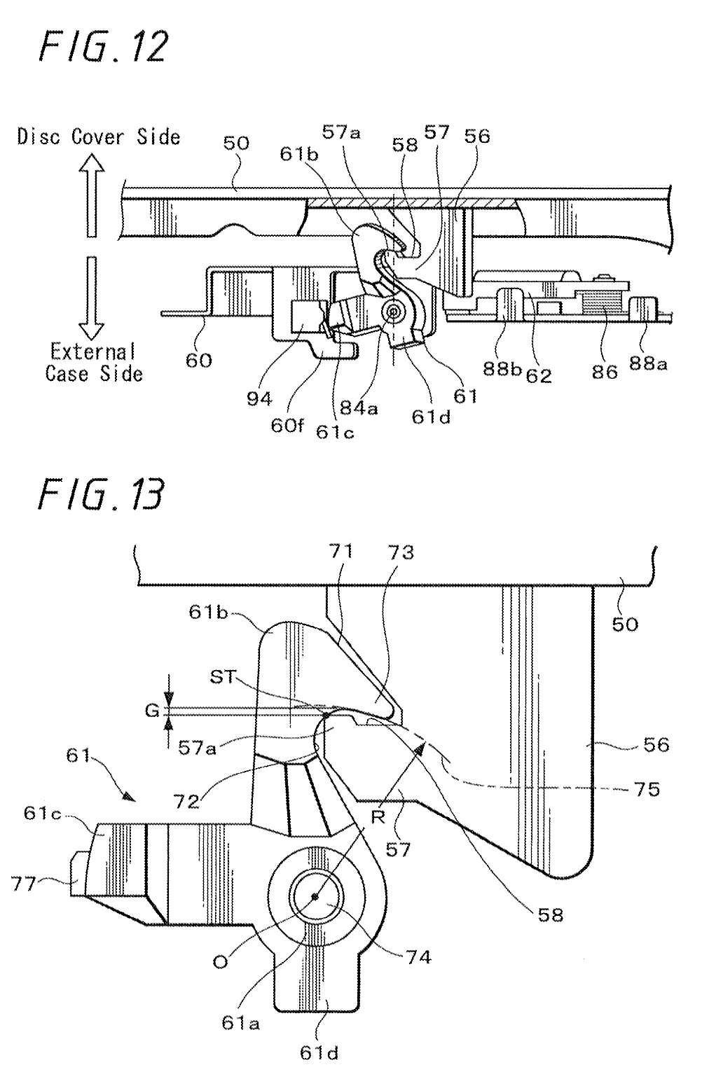

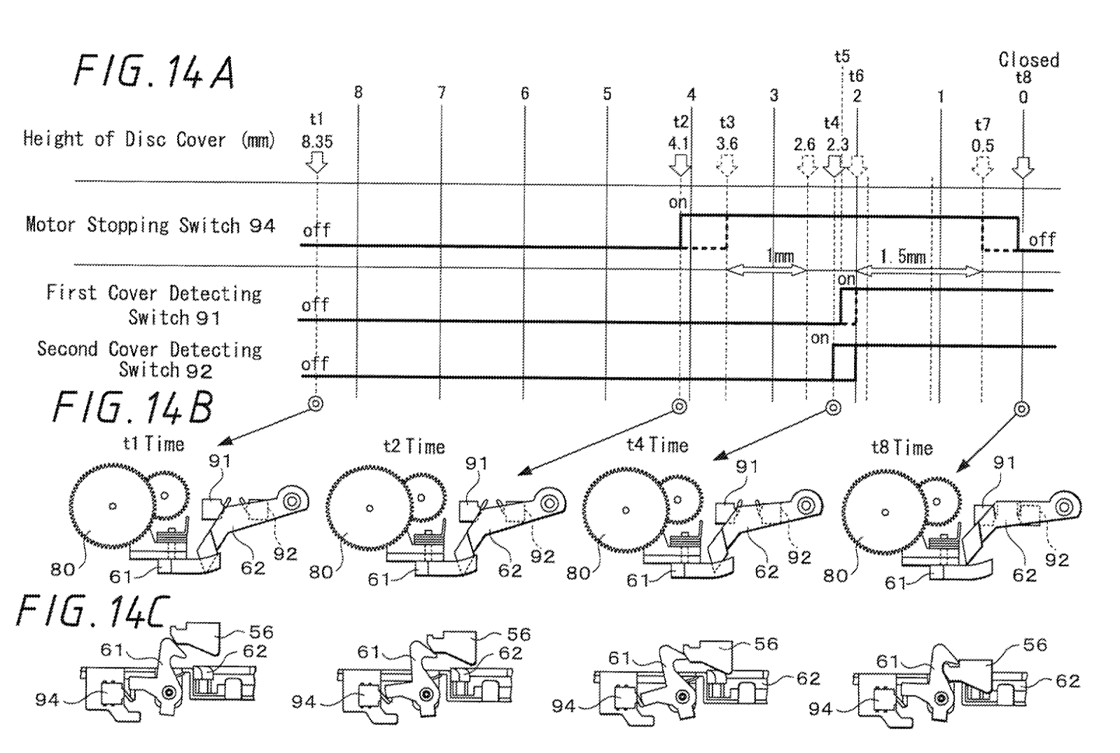

FIGS. 1 to 14 show an embodiment. That is, FIGS. 1 to 3 show a first embodiment of an imaging apparatus according to an embodiment, and are a perspective view when viewing from the front surface side, a perspective view when viewing from the rear surface side when a display device has been opened, and a perspective view when viewing from the front surface side when a disc cover has been opened. FIG. 4 is a diagram useful in showing a driving device-side panel when viewing from an inside thereof. FIGS. 5 to 8 show a cover opening/closing mechanism of the imaging apparatus according to an embodiment, and are a perspective view, a front view, a plan view, and a bottom view. FIGS. 9A to 9C and FIGS. 10A to 10C show a locking claw of an imaging apparatus according to an embodiment, and are a perspective view, a front view, a plan view, a bottom view, and a left side view and right side view, partially in cross section. FIGS. 11A to 11C show a cover opening/closing member of the imaging apparatus according to an embodiment, and are a perspective view, a plan view, and a front view, partially in cross section. FIG. 12 is a diagram showing engagement between the locking claw and the fixed claw according to an embodiment. FIG. 13 is a diagram useful in showing an enlargement of a principal part of FIG. 12. FIG. 14 is a diagram useful in explaining output states of three detectors that detect the position of the disc cover and the like of an imaging apparatus according to an embodiment.

An imaging apparatus according to an embodiment will now be described with reference to FIGS. 1 to 14. The imaging apparatus shown in FIGS. 1 to 3 is a digital camcorder 1 as a first embodiment. The digital camcorder 1 uses an optical disc, which is a specific example of an information recording medium, as a storage medium, converts an optical image to an electrical signal using an imaging element (for example, a CCD (Charge Coupled Device) or a CMOS (Complementary Metal-Oxide-Semiconductor)) as a specific example of an imaging mechanism, and can record the image information on the optical disc and/or can display the image information on a display apparatus formed of a flat panel such as a liquid crystal display.

However, the information recording medium used in the imaging apparatus according to an embodiment is not limited to the optical disc (a DVD-R, DVD-RW, DVD-RAM, or the like) described in this embodiment and it is also preferable to use a disc-shaped recording medium such as an MO, an FD, or other type of recordable magneto-optical disc or magnetic disc. As an electronic appliance that uses such disc-shaped recording medium, it is preferable to realize a magneto-optical-disc-type still camera that uses a magneto-optical disc or a magnetic-disc-type personal data assistant that uses a magnetic disc.

As shown in FIGS. 1 to 3, the digital camcorder 1 includes an external case 2 that is a specific example of a case that constructs the external form, a disc drive apparatus 3 that is enclosed inside the external case 2, rotationally drives an optical disc removably mounted thereupon, and records (writes) and reproduces (reads) an information signal, a lens device 4 that receives light from a subject and directs the light toward an imaging element, a display apparatus 5 that is rotatably attached to the external case 2, and a control circuit that carries out control to drive the disc drive apparatus 3, the lens device 4, the display apparatus 5, and the like.

The external case 2 is formed of a hollow case that is approximately shaped as a rectangular solid. The external case 2 includes a driving device-side panel 6 and a display device-side panel 7 that are disposed facing one another in the left-right direction, a front panel 8 that covers a front opening of a cylinder formed of a combination of both panels 6 and 7, and a rear panel 9 that covers a rear opening of the cylinder. The digital camcorder 1 is used in a state where the length of the digital camcorder 1 is aligned in the front-rear direction and the width (i.e., the next longest dimension) of the digital camcorder 1 is erected. A battery enclosure portion 12 in which a battery device 11 that is a portable power supply is detachably attached is provided on the rear panel 9. The battery enclosure portion 12 is disposed substantially in the center of the rear surface of the external case 2, and the battery device 11 is inserted diagonally from above into the battery enclosure portion 12 and can be removed in the same direction.

The lens device 4 is disposed at an upper part of the external case 2 in a state where an objective lens 15 that is an imaging lens of a lens system is exposed to the front. The lens device 4 is attached to the external case 2 in a state where the optical axis of the lens system is horizontal. Inside the external case 2, an imaging element is attached to a rear of the lens device 4. A viewfinder device 16 that displays an image of the subject inputted from the lens device 4 is disposed behind the lens device 4. A recording button 13 is disposed below the viewfinder device 16 and on the driving device-side panel 6 side of the rear panel 9 to the right of the battery enclosure portion 12.

In addition, an opening that exposes an accessory shoe, on which an accessory such as a video light or external microphone can be detachably mounted, is provided in the top of the external case 2. The accessory shoe is disposed immediately in front of the viewfinder device 16 and in a normal state is covered by a detachable shoe cap 17 that opens and closes the opening. In addition, a light emitter 18 of a flash device is disposed on the front surface of the external case 2. A stereo microphone 19 is internally provided at an upper front part of the external case 2. The shoe cap 17 is disposed behind the microphone 19, and an operation unit 21 formed of a plurality of operation buttons is provided behind the shoe cap 17.

The display apparatus 5 is attached to the driving device-side panel 6 that forms one side surface of the external case 2 so that the position of the display apparatus 5 can be changed. The display apparatus 5 includes a flat panel 22 formed of a flat liquid crystal display or the like, a panel case 23 in which the flat panel 22 is enclosed, and a panel support unit 24 that can support the panel case 23 so that the position of the panel case 23 relative to the external case 2 can be changed. A rectangular opening window 25 that is wider than it is tall is provided on an inner surface of the panel case 23 and the flat panel 22 is fitted into this opening window 25. A menu switching button 26, a zoom button 27, and a start/stop button 28 are also disposed at a lower edge of the inner surface of the panel case 23.

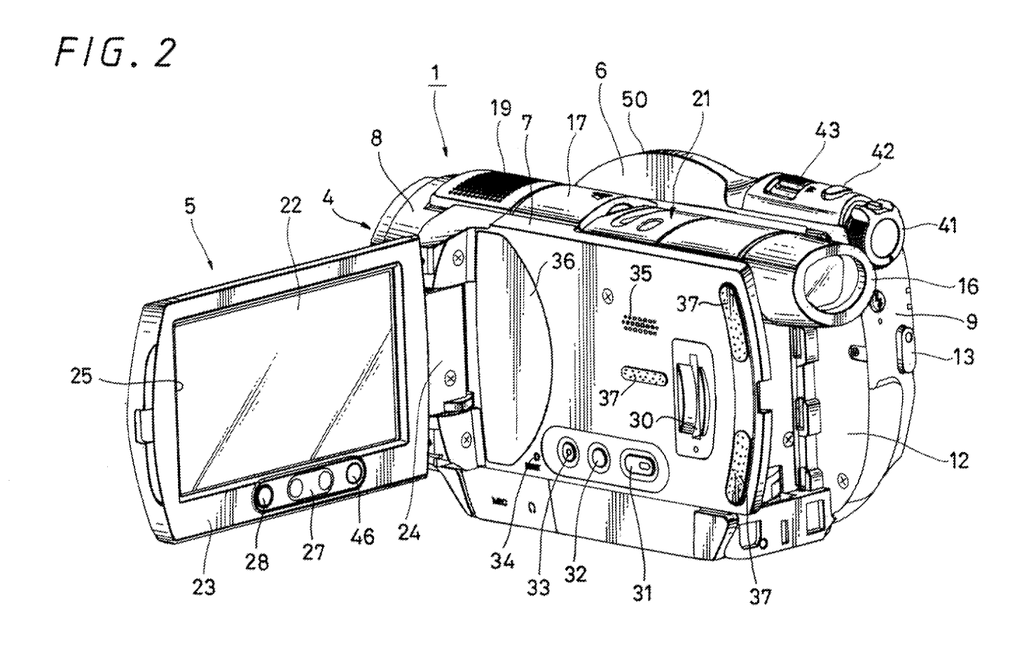

The panel support unit 24 of the display apparatus 5 includes a horizontal rotation unit that makes it possible for the panel case 23 to rotate horizontally by approximately 90° around a vertical shaft as the center of rotation and a front-rear rotation unit that makes it possible for the panel case 23 to rotate by approximately 180° in the front-rear direction around a horizontal shaft as a center of rotation. With this construction, the display apparatus 5 can optionally take any of a stored state where the display apparatus 5 is stored on the side surface of the external case 2 as shown in FIG. 1, a state where the panel case 23 has been rotated by 90° in the horizontal direction so that the flat panel 22 faces backward as shown in FIG. 2, a state where the panel case 23 has been rotated by 180° from such backward-facing state so that the flat panel 22 faces forward, and an intermediate state between any of such states.

A storage medium insertion hole 30 that allows an external storage device, not shown, to be detachably attached, four operation buttons 31 to 34, a large number of tiny through-holes 35 for a speaker device, a protective sheet 36 that protects the flat panel 22, and cushion members 37 for the panel case 23 are provided on the display device-side panel 7. The storage medium insertion hole 30 is formed as a slit corresponding to the size of the information storage medium being used, and is provided so that a length thereof extends in the up-down direction. The storage medium insertion hole 30 is disposed at a position inside the opening window 25 of the panel case 23 on the opposite side of the display device-side panel 7 to the panel support unit 24.

Out of the four operation buttons 31 to 34, the first operation button 31 is a play button, the second operation button 32 is a battery level check button, the third operation button 33 is a menu quick operation button, and the fourth operation button 34 is a reset button. These four operation buttons 31 to 34 are disposed in a horizontal row at a position that is inside the opening window 25 of the panel case 23 on a lower edge side of the display device-side panel 7. The large number of tiny through-holes 35 are also provided at a position that is inside the opening window 25 of the panel case 23 and diagonally above the storage medium insertion hole 30. A speaker device, not shown, is disposed on the inside of such through-holes 35.

The protective sheet 36 protects the flat panel 22 by preventing a metal plate layer of the display device-side panel 7 from being exposed to the surface as the finish surface. Accordingly, the protective sheet 36 is shaped so that one part thereof coincides with a frame part of the panel case 23 that is provided outside the opening window 25, and in particular, so that part of the protective sheet 36 coincides with a vertical part of the frame of the panel case that is close to the panel support unit 24. As examples, polycarbonate (PC) and polypropylene (PP) can be preferably used as the material of the protective sheet 36. Three cushion members 37 are provided on the opposite side of the display device-side panel 7 to the protective sheet 36. Out of the three cushion materials 37, two cushion members 37 are provided a suitable interval apart in the up-down direction and are disposed at positions that coincide with a vertical part of the frame of the panel case 23.

Although not shown, the display device-side panel 7 constructs a so-called hybrid case and has a resin plate layer made of plastic on its surface and a metal plate layer of magnesium alloy or the like on its inside. This means that the display device-side panel 7 has a two-layer structure formed of a resin plate layer and a metal plate layer. A hybrid case constructed in this way can be used as a high-strength frame in spite of being formed with a similar low cost as a case formed of plastic, and can be manufactured at an extremely low cost compared to the case where die cast is used on the surface. Also, switches and other electronic components, small mechanical components, and the like can be directly attached to a hybrid case, which means that the internal frame construction can be simplified. In addition, by sticking the protective sheet 36 and the like onto the surface of the hybrid case, it may be possible to reduce the contact temperature for the user and to increase heat dissipation.

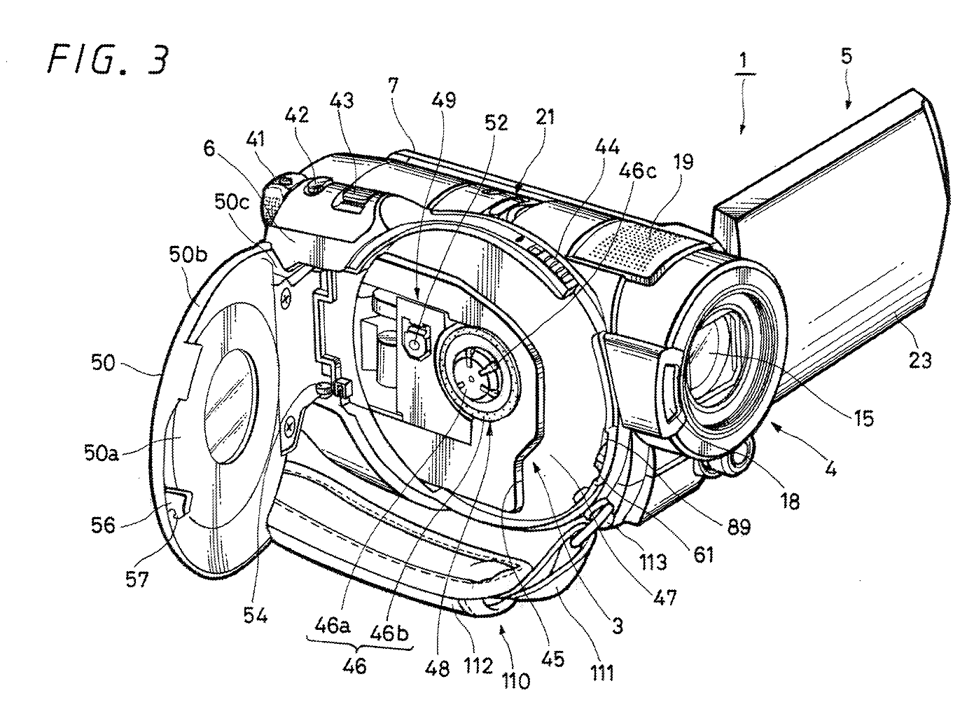

As shown in FIGS. 3 and 4, the driving device-side panel 6 that is the side surface on the opposite side of the external case 2 to the display apparatus 5 is formed of a flat portion 6a that is a main surface to which a disc cover 50 is attached and a circumferential edge portion 6b that is continuous so as to surround the outer edge of the flat portion 6a. The circumferential edge portion 6b of the driving device-side panel 6 is formed so as to be continuous around substantially the entire outer edge of the flat portion 6a. A power switch 41 that also serves as a mode selection switch, a shutter button 42 for taking a still image, a zoom lever 43 that continuously enlarges images (i.e., movement toward telephoto end) or reduces images (i.e., movement toward wide-angle end) within a predetermined range, and an unlock button 44 for unlocking the disc cover 50 are provided on the edge portion 6b.

The power switch 41 has a function for turning the power on or off when the power switch 41 is rotated and a function for repeatedly switching between a plurality of function modes when the power switch 41 is rotated in a state where the power is already on. The mode switching function is carried out by rotating the power switch 41 and can select a desired mode out of the three choices of “photo mode”, “video mode”, and “play/edit mode”. The shutter button 42 is used to take still images (i.e., photos), with one still image being taken every time the shutter button 42 is pressed. The zoom lever 43 is used to enlarge images during filming and playback, and can adjust the magnification of images within a predetermined range in infinite steps in accordance with the operated amount of the zoom lever 43.

An opening 45 of a predetermined shape is provided at a predetermined position on the flat portion 6a of the driving device-side panel 6. The opening 45 exposes part of an upper surface portion of the disc drive apparatus 3. Accordingly, the shape of the opening 45 corresponds to the shape of the disc drive apparatus 3 when the disc drive apparatus 3 is viewed from above, and is slightly larger than such shape of the disc drive apparatus 3. Part of the upper surface portion of the disc drive apparatus 3 that is attached to a mechanical chassis, not shown, is loosely fitted into the opening 45, so that such upper surface portion is exposed to an outer surface of the external case 2.

A turntable 46 that is a disc mounting portion on which an optical disc (disc-shaped recording medium) is detachably mounted and a certain region around the turntable 46 form a disc enclosure portion 47 of the disc drive apparatus 3. In the present embodiment, the disc enclosure portion 47 is formed as a region of a size that corresponds to an optical disc with a diameter of 8 cm. A table rotating device 48 of the disc drive apparatus 3 is disposed in approximately the center of the disc enclosure portion 47, and an 8 cm-diameter optical disc (such as a DVD or CD-RW) as a specific example of a disc-shaped recording medium can be mounted onto the turntable 46 which is positioned in the center of the table rotating device 48.

Although only part is shown in FIG. 3, the disc drive apparatus 3 includes the mechanical chassis that is attached to the external case 2, the table rotating device 48 that is fixed to the mechanical chassis, and an optical pickup 49 that is a specific example of a pickup device. The mechanical chassis is formed of a conductive plate material and is elastically supported on the external case 2 via a plurality of mount insulators formed of elastic bodies that are formed of an elastic material. The table rotating device 48 mounted on the mechanical chassis is formed of a spindle motor fixed to the mechanical chassis and the turntable 46 that is fixed to a rotating portion of the spindle motor.

The turntable 46 is formed of an engaging portion 46a that engages a center hole of the optical disc and a mounting portion 46b on which the circumferential edge portion of the center hole is mounted. In addition, a plurality of engagement claws 46c that engage the circumferential edge portion of the center hole of the optical disc to hold the optical disc are provided around the circumference of the engaging portion 46a of the turntable 46. The engagement claws 46c are pressed outward in the radial direction by springs and the optical disc is positioned on and fixed to the engaging portion 46a by the spring force of the springs.

Although not shown, the optical pickup 49 includes a biaxial actuator that includes a pickup lens 52 that faces the information recording surface of the optical disc and a slide member on which the biaxial actuator is mounted. The slide member is movable and is guided by two guide shafts. The two guide shafts are disposed in parallel on both sides of the spindle motor, and a pickup moving device is provided in the vicinity of one guide shaft. The pickup moving device includes a feed screw shaft engaged by a feed nut which is attached to the slide member and a feed motor that has the feed screw shaft as a rotational shaft. The feed screw shaft is set in parallel to the guide shafts of the optical pickup 49 and is rotatably supported on the mechanical chassis.

In this way, by driving the feed motor to rotate the feed screw shaft, the optical pickup 49 is selectively moved in a direction that approaches the turntable 46 or a direction that moves away from the turntable 46 in accordance with the direction of rotation of the feed screw shaft. The mechanical chassis, the table rotating device 48, the optical pickup 49, the pickup moving mechanism, and other related mechanisms construct the disc drive apparatus 3.

The disc enclosure portion 47 of the disc drive apparatus 3 in which the table rotating device 48 is disposed is openably covered by the disc cover 50, a side surface portion of which is rotatably supported on the driving device-side panel 6. The disc cover 50 is formed in a suitable shape for the disc enclosure portion 47 and is approximately circular in the present embodiment. The disc cover 50 includes a flat portion 50a that forms a main surface of the disc cover 50 and is slightly curved to cover the outside of the disc enclosure portion 47 and a circumferential surface portion 50b that is continuous around substantially the entire outer circumferential edge of the flat portion 6a. The circumferential surface portion 50b of the disc cover 50 is constructed so as to fit into an outer circumferential cutaway portion of the disc enclosure portion 47 on the driving device-side panel 6.

In the present embodiment, the disc cover 50 is formed in a shell shape where around ⅚ (i.e., approximately 300°) of the outer circumferential edge is circular (the circular part should be approximately ¾ of the entire edge or more), with the remaining part being formed of a rectangular portion 50c that protrudes out to the side. A cover rotational shaft portion 54, which is a center of rotation for opening and closing the disc cover 50, is attached to the rectangular portion 50c. Although not shown, the cover rotational shaft portion 54 is formed of a support shaft that is attached to the rectangular portion 50c and a shaft bearing member with a pair of bearing arms that are fixed to and support both ends of the support shaft, so that the disc cover 50 can be rotatably supported by fixing the shaft bearing member to the driving device-side panel 6. The cover rotational shaft portion 54 is also provided with a stopper portion that sets the maximum opening angle of the disc cover 50 (for example, 90°).

This cover rotational shaft portion 54 is attached to the driving device-side panel 6 with the axial direction of the support shaft thereof set in the up-down direction. By doing so, the disc cover 50 is rotatably supported via the cover rotational shaft portion 54 on the rear portion of the driving device-side panel 6. As a result, if the front surface of the digital camcorder 1 is regarded as the front, the disc cover 50 can rotate by approximately 90° to the side so as to become open to the front. Note that the cover rotational shaft portion 54 enables the disc cover 50 to be stopped at a desired opened position within a predetermined range for the angle of opening and has a spring member installed so as to press the disc cover 50 back toward such predetermined range when the maximum angle of opening is exceeded.

A cover opening/closing mechanism 55 of the disc cover 50 is connected to the disc cover 50 and the driving device-side panel 6. The cover opening/closing mechanism 55 has a locking function for locking the disc cover 50 in a closed state where the disc cover 50 closes the disc enclosure portion 47 and an unlocking function for unlocking the disc cover 50. The disc enclosure portion 47 is opened and closed by the disc cover 50 via the cover opening/closing mechanism 55, with the cover opening/closing mechanism 55 also locking and unlocking the disc cover 50.

As shown in FIGS. 3 to 8, the cover opening/closing mechanism 55 includes a fixed claw 56 that is fixed to the disc cover 50, a base plate 60 as a specific example of a “case-side member” that is fixed to the driving device-side panel 6 that constructs part of the external case 2, a locking claw 61 and a cover detecting member 62 that are rotatably supported on the base plate 60, an end surface cam 63 that is rotatably supported on the base plate 60, and a cam driving unit 64 that rotates the end surface cam 63.

As shown in FIGS. 12 and 13, the fixed claw 56 is integrally provided on an inner surface of the flat portion 50a that is the main surface of the disc cover 50 so as to protrude in a direction that is substantially perpendicular to the main surface. The fixed claw 56 is formed in a wedge shape that is erected on the flat portion 50a and is integrally molded with the disc cover 50 using the same material. The front end of the fixed claw 56 has an inclined surface portion that is inclined in one direction, and a hook portion 57, which protrudes in a direction (i.e., to the side) that is parallel to the plane of the flat portion 50a, is provided on this inclined surface portion. In addition, a convex part 57a that protrudes in the direction of the disc cover 50 is provided at the front end of the hook portion 57. Due to the convex part 57a being provided, a concave part 58 that is depressed toward the front end of the fixed claw 56 is formed inside the hook portion 57.

The base plate 60 is a member formed of a plate material on which the components of the cover opening/closing mechanism 55 aside from the fixed claw 56 are mounted, and is screwed to the inner surface of the driving device-side panel 6 in the state shown in FIG. 4. Thus, the base plate 60 has a shape that corresponds to the shape of an enclosure portion on the same side of the driving device-side panel 6 as the front of the imaging apparatus so as to fit into such enclosure. In the present embodiment, when viewed from above, the base plate 60 is approximately a semi-circle shape. A stepped part 60a is provided in the center of the base plate 60 so as to divide the base plate 60 in two in the longitudinal direction, and a first region is set on one side and a second region is set on the other side with the stepped part 60a as the boundary. Fixing portions 60b, 60c for screwing the base plate 60 to the driving device-side panel 6 are provided at both ends in the longitudinal direction of the base plate 60. An insertion through-hole 65a through which a fixing screw is inserted and a positioning hole 65b for positioning the base plate 60 are provided in the fixing portions 60b, 60c.

The locking claw 61, the end surface cam 63, and an intermediate gear 66 are disposed in the first region divided by the stepped part 60a of the base plate 60. The locking claw 61 is constructed as shown in FIGS. 9A to 9C and 10A to 10C. That is, the locking claw 61 includes a cylindrical shaft portion 61a formed in a cylindrical shape, a claw portion 61b formed so as to protrude outward in the radial direction from the outer circumferential surface of the cylindrical shaft portion 61a, an arm portion 61c, and a spring holding portion 61d. The arm portion 61c is disposed at a position that is rotationally displaced by approximately 90° to the claw portion 61b, and the spring holding portion 61d is disposed at a position that is rotationally displaced by approximately 90° to the arm portion 61c. Accordingly, the spring holding portion 61d and the claw portion 61b are provided on opposite sides that are rotationally displaced by approximately 180°.

The claw portion 61b of the locking claw 61 is wedge-shaped and includes an inclined surface 71 on one side. In addition, a cutaway portion 72 with an opening that faces diagonally inward in the radial direction is provided in the center of the inclined surface 71 side of the claw portion 61b. By providing the cutaway portion 72, a hook portion 73 whose front end is shaped like a sharp beak is formed on the claw portion 61b. The bottom of the cutaway portion 72 is formed as a circular curved surface of a suitable size. The inner surface of the hook portion 73 is an arc-shaped guide surface 75 formed with a radius of curvature R about a center O of a center hole 74 of the cylindrical shaft portion 61a. The guide surface 75 is continuous with the circular curved surface at the bottom of the cutaway portion 72.

The arm portion 61c of the locking claw 61 includes a perpendicular direction arm 76a that extends in a direction perpendicular to the depth direction of the center hole 74 of the cylindrical shaft portion 61a and a parallel direction arm 76b that is continuous with the front end of the perpendicular direction arm 76a and extends in a direction parallel to the depth direction of the center hole 74. A cam contacting portion 77 that is in slidable contact with the cam surface 63a of the end surface cam 63 is provided at the front end of the parallel direction arm 76b. A slit 79 for engaging one end of a first torsion spring as a specific example of an pressing member is provided in the spring holding portion 61d of the locking claw 61.

The end surface cam 63 is provided with a cam surface 63a on the end surface of a cylindrical body, and is integrally formed so as to be concentric with the surface of a cam gear 80. The upper end surface of the end surface cam 63 is a raised end, one surface of the cam gear 80 is a lowered end, and the part in between is continuous with a constant angle of inclination. The cam gear 80 that is integral with the end surface cam 63 is rotatably supported by a first support shaft 81 that is erected on the base plate 60. The diameter of the cam gear 80 is formed larger than the diameter of the end surface cam 63. The cam gear 80 engages a small diameter gear of the intermediate gear 66 that is rotatably supported by a second support shaft 82 erected on the base plate 60. The intermediate gear 66 and the small diameter gear are integrally formed and the intermediate gear 66 is engaged by a worm gear 83.

The worm gear 83 is fixed to a rotational shaft of a driving motor 67 and integrally rotates with the rotational shaft. The driving motor 67 is screwed to the stepped part 60a of the base plate 60 by a fixing screw in a state where the rotational shaft has been passed through a hole provided in the stepped part 60a. The cover detecting member 62 is rotatably supported by a second rotational shaft 84 in the second region divided by the stepped part 60a. The second rotational shaft 84 is erected on the base plate 60. The cover detecting member 62 has the construction shown in FIGS. 11A to 11C. That is, the cover detecting member 62 is formed of a bar-shaped member that is bent in a V shape, with a rotational shaft portion 62a provided at one end in the longitudinal direction and an input portion 62b that is pressed and operated by the fixed claw 56 provided at the other end in the longitudinal direction.

The rotational shaft portion 62a of the cover detecting member 62 has a center hole 85. A second torsion spring 86 as one specific example of a second pressing member is attached to an outer circumferential surface of the rotational shaft portion 62a with a suitable gap in between. One end of the second torsion spring 86 is inserted into a holding channel 87 provided in the cover detecting member 62 and is supported by engaging a spring holding arm 87a provided inside the holding channel 87. In addition, a detection cam portion 62c used to detect the position of the fixed claw 56 is provided between the rotational shaft portion 62a and the input portion 62b of the cover detecting member 62. A stopper portion 62d that limits the amount of rotation of the cover detecting member 62 is also provided between the detection cam portion 62c and the input portion 62b.

The cover detecting member 62 with the construction described above is rotatably supported on the second rotational shaft 84 in a state where the input portion 62b is disposed in approximately the center in the longitudinal direction of the base plate 60. The other end of the second torsion spring 86 whose coil portion is mounted on the rotational shaft portion 62a engages a spring holding arm 88a provided on the base plate 60. The cover detecting member 62 is pressed by the spring force of the second torsion spring 86 in the anticlockwise direction in FIG. 8. Rotation of the cover detecting member 62 due to the spring force of the second torsion spring 86 is prevented by a stopper arm 88b provided on the base plate 60.

For the cover detecting member 62, two cover detecting switches 91, 92 that are specific examples of a position detector for detecting the position of the disc cover 50 via the fixed claw 56 are provided in the periphery of the detection cam portion 62c. The reason that two cover detecting switches are provided as a position detector is that it may be possible to reliably and stably detect the opened/closed state of the disc cover 50 by detecting the position of the disc cover 50 using the two cover detecting switches 91, 92. That is, for an information recording/reproducing device that uses an optical pickup, in the worst case scenario there is the risk of laser light entering the user's eyes if the disc cover 50 is opened while laser light is being emitted. For this reason, when the disc cover 50 is open, the optical pickup is always stopped so that no laser light is emitted.

The two cover detecting switches 91, 92 are disposed on both sides of the detection cam portion 62c which is provided so as to protrude from one surface of the cover detecting member 62. These two cover detecting switches 91, 92 are constructed so as to be turned on and off by rotation of the cover detecting member 62 at different timing, as described later. Note that the two cover detecting switches 91, 92 may be disposed with one on top of the other at the same position. The two cover detecting switches 91, 92 are also mounted at predetermined positions on a flexible circuit board 93. By fixing the flexible circuit board 93 to a predetermined position of the base plate 60, the two cover detecting switches 91, 92 are attached to predetermined positions on the base plate 60.

As shown in FIGS. 5 to 8, the locking claw 61 is rotatably supported on the base plate 60 so that the locking claw 61 is disposed inside the first region divided by the stepped part 60a of the base plate 60 and the claw portion 61b faces the detection cam portion 62c of the cover detecting member 62 disposed inside the second region. That is, the locking claw 61 is attached to a first rotational shaft 84a that is erected on the shaft holding arm 60d of the base plate 60 by fitting the first rotational shaft 84a into the center hole of the cylindrical shaft portion 61a. The shaft holding arm 60d is provided so as to be erected in the same direction as the stepped part 60a and extends in a direction that is substantially perpendicular to the stepped part 60a. As a result, a line produced by extending the central axis of the first rotational shaft 84a that is fixed to the shaft holding arm 60d extends in a direction that is substantially perpendicular to the rotational shaft of the driving motor 67 that is fixed to the stepped part 60a at a position that is displaced by a predetermined amount in the height direction from the rotational shaft.

With this construction, the claw portion 61b of the locking claw 61 faces the input portion 62b of the cover detecting member 62 on one side in the width direction of the base plate 60, the arm portion 61c extends toward the end surface cam 63, and the cam contacting portion 77 provided at the front end thereof makes surface contact with the cam gear 80. A coil portion of a first torsion spring 78, one end of which engages the spring holding portion 61d, is attached to the first rotational shaft 84 that supports the locking claw 61. The other end of the first torsion spring 78 engages the shaft holding arm 60d, and due to the spring force of the first torsion spring 78, the locking claw 61 is pressed in a direction where the hook portion 73 of the claw portion 61b approaches the input portion 62b of the cover detecting member 62. Here, the cam contacting portion 77 provided at the front end of the arm portion 61c is positioned on the movement path of the end surface cam 63 and the cam contacting portion 77 is pressed toward the cam gear 80 by the spring force of the first torsion spring 78.

A motor stopping switch 94 that is switched on and off when the locking claw 61 is rotated is also provided on the base plate 60. The motor stopping switch 94 is attached by screws via the flexible circuit board 93 to an attachment arm 60e provided on the base plate 60. The attachment arm 60e is provided so as to be erected in the same direction as the shaft holding arm 60d. The operator of the motor stopping switch 94 is disposed facing the arm portion 61c of the locking claw 61. The motor stopping switch 94 is turned on by the arm portion 61c when the fixed claw 56 has moved in a direction so as to engage the locking claw 61 and outputs an ON signal to a control device. Accordingly, the supplying of power to the driving motor 67 is cut off to stop the driving motor 67. A stopper portion 60f that limits the amount of rotation of the locking claw 61 is provided on the front end of the attachment arm 60e.

As shown in FIG. 4, a cover opening slide button (eject button) 95 used to open the disc cover 50 is provided at a predetermined position on an inner surface of the driving device-side panel 6 to which the cover opening/closing mechanism 55 with the construction described above is attached. The cover opening slide button 95 is disposed at an upper front part of the driving device-side panel 6 and can move by a predetermined distance in the front-rear direction. The cover opening slide button 95 is restricted to only linear movement in the front-rear direction by a moving restricting member 96. In addition, the cover opening slide button 95 is constantly pressed toward the front by a return spring 97. An eject detection switch 98 that detects movement of the cover opening slide button 95 is disposed in the periphery of the cover opening slide button 95. The eject detection switch 98 is mounted on a wiring circuit 99 that is fixed to a front end of a branch portion of the flexible circuit board 93.

Also, as shown in FIG. 3, the hand strap 110 is attached on the driving device-side panel 6 so as to surround the disc cover 50 in the horizontal direction. The hand strap 110 supports a user's hand that is holding a grip portion (the driving device-side panel 6 and the disc cover 50) of the external case 2 and prevents the user from dropping the digital camcorder 1. The hand strap 110 is made up of a support belt 111, both ends of which are fixed to the driving device-side panel 6, and a protective pad 112 that is attached to the support belt 111 and contacts the back of the user's hand. One end of the support belt 111 is connected to an attachment clip fixed to a lower front part of the driving device-side panel 6 and the other end is inserted into and through a through-hole provided at an intermediate position at the rear of the driving device-side panel 6 and is fixed to an attachment clip attached inside the through-hole.

As one example, ABS (Acrylonitrile Butadiene Styrene resin) can be preferably used as the material of the driving device-side panel 6 and the display device-side panel 7 that construct the external case 2, the disc cover 50, the locking claw 61, and the cover detecting member 62. However, it should be obvious that the material is not limited to ABS and that other engineering plastics can be used. Aside from composite resins, metal such as aluminum alloy can be used. Also, metal such as steel or stainless steel can be preferably used as the material of the base plate 60. However, it should be obvious that the material is not limited to a metal material and that ABS or other engineering plastic can be used.

When the cover opening/closing mechanism 55 is attached to a predetermined position on the driving device-side panel 6 as described above, as shown in FIG. 3, the claw portion 61b of the locking claw 61 and the input portion 62b of the cover detecting member 62 face one another in an opening 89 provided at the outer circumferential edge of the disc enclosure portion 47 of the driving device-side panel 6. In particular, the front portion of the claw portion 61b of the locking claw 61 protrudes out toward the surface through the opening 89. The cover opening slide button 95 is pressed by the return spring 97 and therefore moves in the direction of a closed position.

From this state, the user can close the disc enclosure portion 47 using the disc cover 50 by simply pressing the disc cover 50 with his or her finger. When the user presses the disc cover 50 with his or her finger, the fixed claw 56 provided on the disc cover 50 approaches the opening 89 in the driving device-side panel 6 and the front end surface of the fixed claw 56 contacts the claw portion 61b of the locking claw 61 and the input portion 62b of the cover detecting member 62 at approximately the same time. By doing so, the locking claw 61 is rotated in the anticlockwise direction in FIG. 12 around the first rotational shaft 84a as a center of rotation against the spring force of the first torsion spring 78. As a result, the (rotating) hook portion 73 that is provided on the claw portion 61b of the locking claw 61 is guided by the (fixed) hook portion 57 provided on the inclined surface side of the fixed claw 56 and therefore rotates backward, i.e., in the anticlockwise direction.

In addition, when the (rotating) hook portion 73 of the claw portion 61b passes the (fixed) hook portion 57 of the fixed claw 56 due to the disc cover 50 being pressed in the closing direction, the locking claw 61 rotates in the clockwise direction due to the spring force of the first torsion spring 78, resulting in the state shown in FIG. 12. The cutaway portion 72 of the claw portion 61b into which the (fixed) hook portion 57 becomes inserted is formed with a suitable size and shape for the (fixed) hook portion 57. In addition, the bottom of the cutaway portion 72 is formed in an arc so as to be able to catch on the convex part 57a provided at the front end of the (fixed) hook portion 57. The point of contact ST between the (fixed) hook portion 57 and the (rotating) hook portion 73 where the transmission torque acts is set almost directly above the center O of the cylindrical shaft portion 61a that is the center of rotation of the locking claw 61.

As a result, the (rotating) hook portion 73 can reliably and easily catch on the (fixed) hook portion 57. In addition, since the inner surface of the hook portion 73 is the guide surface 75 that is curved with the radius of curvature R about the center O of the cylindrical shaft portion 61a, the hook portion 73 can smoothly move and catch on the (fixed) hook portion 57. Also, a part of the (rotating) hook portion 73 located inside the peak of the (rotating) hook portion 73 is arc-shaped so that the distance from the center O to the point of contact ST between the (fixed) hook portion 57 and the (rotating) hook portion 73 decreases in accordance with the amount by which the (rotating) hook portion 73 has rotated. This means that a pulling force reliably acts on the disc cover 50 via the fixed claw 56 due to the energizing force of the first torsion spring 78 that presses the locking claw 61.

By doing so, it is possible to increase the distance G by which the fixed claw 56 is pulled by the locking claw 61 and to reduce rattling (i.e., the gap between the disc cover 50 and the external case 2) when the disc cover 50 is locked. In addition, since the front end of the fixed claw 56 protrudes toward the disc cover 50 as the convex part 57a, it is possible to insert the locking claw 61 deeply and to have the locking claw 61 reliably catch on the fixed claw 56. Since the locking claw 61 is rotated by the end surface cam 63 that is integrated with the cam gear 80, it will be possible to easily rotate the end surface cam 63 even if the spring force of the first torsion spring 78 is increased. This means that the spring force of the first torsion spring 78 can be increased to hold the fixed claw 56 more tightly. The locked state where the fixed claw 56 is caught and held by the locking claw 61 is shown in FIG. 13.

An operation where the disc cover 50 is opened by the cover opening/closing mechanism 55 can be carried out easily by merely operating the cover opening slide button (i.e., eject button) 95, for example. As shown in FIG. 4, when an operation that slides the cover opening slide button 95 in the opening direction is carried out, such sliding operation is detected by the eject detection switch 98. By doing so, an open cover detection signal is outputted to the control device, and as a result, a driving signal is outputted from the control device to the driving motor 67 of the cover opening/closing mechanism 55 so that the driving motor 67 is rotationally driven in a predetermined direction. By doing so, the rotational force of the driving motor 67 is transmitted from the worm gear 83 fixed to the rotational shaft of the driving motor 67 to the intermediate gear 66 and from the small-diameter gear of the intermediate gear 66 to the cam gear 80, so that the end surface cam 63 is rotationally driven together with the cam gear 80.

When the end surface cam 63 rotates, the cam contacting portion 77 provided at the front end of the arm portion 61c of the locking claw 61 is moved across the cam surface 63a corresponding to the rotated amount of the end surface cam 63. By doing so, the (rotating) hook portion 73 of the locking claw 61 is rotated in the anticlockwise direction in FIG. 13 away from the (fixed) hook portion 57 of the fixed claw 56. By rotating the (rotating) hook portion 73 by a predetermined amount, the (rotating) hook portion 73 and the (fixed) hook portion 57 are disengaged. By doing so, the spring force of an pressing member (torsion spring), not shown, that constantly presses the disc cover 50 in the opening direction causes the disc cover 50 to move by a predetermined amount in a direction so as to open the disc enclosure portion 47. As a result, the disc cover 50 is freed and by thereafter widely opening the disc cover 50 by hand, the disc enclosure portion 47 is fully opened so that operations that load an optical disc onto or unload an optical disc from the disc enclosure portion 47 can be carried out.

When doing so, due to the rotation of the locking claw 61, the motor stopping switch 94 is switched on and a detection signal of the motor stopping switch 94 is transmitted to the control device. By doing so, the outputting of the control signal that is outputted from the control device to drive the spindle motor is stopped and while the motor stopping switch 94 is on, emission of laser light from the optical pickup is stopped.

At the same time or slightly before or after, the cover detecting member 62 is rotated by the fixed claw 56. That is, due to the pressing force of the fixed claw 56, the cover detecting member 62 rotates in the clockwise direction in FIG. 8 about a second rotational shaft 84b as the center of rotation. By doing so, the two cover detecting switches 91, 92 that are set inside the cover detecting member 62 are switched on by the detection cam portion 62c of the cover detecting member 62 and the respective detection signals are outputted to the control device. The control device determines whether the disc cover 50 is opened or closed based on such detection signals. That is, in a state where “the motor stopping switch 94 is off” and “both the cover detecting switches 91, 92 are on”, the cover opening/closing mechanism 55 determines that the disc cover 50 is closed.

A timing chart for these three switches 91, 92, and 94 is shown in FIG. 14. FIG. 14 shows the height (opening) of the disc cover 50 in millimeters and the on/off timing of these three switches 91, 92, and 94. As shown in FIG. 14, at time t1, the fixed claw 56 starts to contact the locking claw 61. At this time, the height (opening) in millimeters of the disc cover 50 is 8.35 mm, for example. The two cover detecting switches 91, 92 and the motor stopping switch 94 are all off. From this state, the disc cover 50 moves closer to the external case 2 and at time t2, the motor stopping switch 94 is switched on by the arm portion 61c of the locking claw 61. As a result, the spindle motor is stopped and there is no emission of laser light from the optical pickup. Time t3 in FIG. 14 shows the case where the motor stopping switch 94 is switched on when the height of the disc cover 50 is 3.6 mm.

Next, when time t4 is reached, the second cover detecting switch 92 is switched on. After this, when time t5 is reached, the first cover detecting switch 91 is switched on. Accordingly, since all three switches are switched on, it becomes possible to drive the disc drive apparatus 3, so that the spindle motor can rotate and laser light can be emitted from the optical pickup. Time t6 in FIG. 14 shows the case where the first cover detecting switch 91 is switched on when the height of the disc cover 50 is 2.0 mm. Time t6 also indicates when the second cover detecting switch 92 is switched from off to on.

Time t8 shows where the motor stopping switch 94 has switched from on to off. This switching point can be set so that the motor stopping switch 94 switches from on to off just before the disc cover 50 becomes completely closed (for example, when the height is 0.5 mm), such as at time t7.

The present application is not limited to the embodiment described above and shown in the drawings and can be subjected to a variety of modifications within the scope of the present application. For example, although an example where the fixed claw 56 is provided on the disc cover 50 and a rotatable locking claw 61 is provided on the external case 2 has been described in the above embodiment, it is possible to use the opposite construction where the locking claw 61 is provided on the disc cover 50 and the fixed claw 56 is provided on the external case 2. In addition, although a construction has been described where the base plate 60 is provided as a specific example of a case-side member and the end surface cam 63 and the locking claw 61 are attached via the base plate 60 to the driving device-side panel that constructs part of the external case 2, it should be obvious that it is also possible to use a construction where the base plate 60 is omitted and components such as the end surface cam 63 and the locking claw 61 are directly attached to the driving device-side panel.

Also, although an example where the present application is adapted to a digital camcorder as a specific example of an imaging apparatus has been described in the embodiment described above, it should be evident that the present application can be applied to a variety of apparatuses such as a digital still camera or other imaging apparatus, a mobile telephone, a PHS (Personal Handyphone System), a communication appliance, or other type of imaging apparatus.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An imaging apparatus comprising:
a table rotating device that rotationally drives a disc-shaped recording medium detachably placed on a turntable;
a pickup device capable of recording an information signal of an image corresponding to light from a subject inputted via at least a lens device onto the disc-shaped recording medium rotationally driven by the table rotating device;
an external case that includes a disc enclosure portion that encloses the table rotating device and the pickup device and on which the turntable is disposed;
a disc cover that is rotatably attached to the external case so that the disc enclosure portion can be opened and closed, and
a cover opening/closing mechanism capable of locking and unlocking the disc cover in a state where the disc enclosure portion is closed, wherein
the cover opening/closing mechanism includes a fixed claw integrally provided with the disc cover and a locking claw that is rotatably supported on one of the external case and a case-side member fixed to the external case,
the fixed claw protrudes in a direction that is substantially perpendicular to a main surface of the disc cover, and
a convex portion that protrudes toward the disc cover is provided at a front end of the fixed claw.

2. An imaging apparatus according to claim 1, wherein
a position detector for detecting a position of the fixed claw is provided on one of the external case and the case-side member.

3. An imaging apparatus according to claim 2, wherein
the position detector having two position detectors that detect the position of the fixed claw at a same position or at two positions that are proximate.

4. An imaging apparatus according to claim 1, wherein
the cover opening/closing mechanism includes an end surface cam that is rotatably supported on one of the external case and the case-side member,
a cam contacting portion that is in sliding contact with a cam surface of the end surface cam is provided on the locking claw, and
the locking claw is caused to engage and disengage the fixed claw due to the locking claw being rotated based on rotation of the end surface cam.

5. An imaging apparatus according to claim 4, wherein
the cam contacting portion is provided at a position that is biased from a center of rotation of the locking claw and extends in a direction in which the center of rotation of the locking claw extends.
